(19) United States
(12) Patent Application Publication
(10) Pub. No.: US 2006/0283913 A1
(43) Pub. Date: Dec. 21, 2006

(54) Apparatus for manufacturing prefabricated sandwiched building panels

(75) Inventor: Angelo Candiracci, Fano (IT)

Correspondence Address: COHEN, PONTANI, LIEBERMAN & PAVANE, 551 FIFTH AVENUE, SUITE 1210, NEW YORK, NY, 10176, US

(73) Assignee: Emmedue S.p.A.

(21) Appl. No.: 11/447,809

(22) Filed: Jun. 6, 2006

(30) Foreign Application Priority Data
Jun. 15, 2005 (IT) PS 2005 A 000015

(51) Int. Cl. A47J 36/02

(52) U.S. Cl. 228/101

(57) ABSTRACT

Machine for producing prefabricated sandwiched building panels having upper and lower grids and insulating material between the grids. The machine has a pair of transversely movable insertion devices suitable for inserting sections of metal wire into the panel, a pair of transversely movable cutting devices vertically coaxial with the insertion devices and interposed between the insertion devices and the panel for cutting the wire at the surface of the upper grid of the panel, a pair of transversely movable welding devices positioned below the panel and vertically coaxial to the insertion devices and the cutting devices for welding the lower end of the wires to the lower metal grid, and a pair of transversely movable upper welding devices one production step behind the cutting devices and positioned axially parallel to the cutting devices for welding the upper end of the wires to the upper metal grid.

### BACKGROUND OF THE INVENTION

1. Field of the Invention

The present invention is directed to the field of apparatus for manufacturing building panels used in construction and, more particularly, to apparatus for use in manufacturing building panels formed of metal grids and foamed plastic material.

2. Description of the Related Art

Sandwiched building panels made up of steel wire grids and foamed plastic material are well-known. Such panels are generally formed with a core of foamed plastic, as for example polystyrene, enclosed between two electrically welded steel wire grids. The grids are held together by steel wires that are welded to and disposed transverse to the grids, thereby perforating the core. The grids and foam core thus together form a modular unit that can be interconnected to other, similar units to form thereby a larger prefabricated building panel for use in construction.

Such prefabricated modular panels can be readily installed on site and covered with plaster retained by the metal grids to form sturdy walls with good antiseismic, thermoacoustic-insulating, fireproofing, thermal-insulating and impact-resistant properties.

Furthermore, an opposed pair of such panels can, with excellent results, be used as disposable formwork to cast concrete. To do so, concrete is poured between the pair of panels to form a single body, with the panels adhering to the concrete so as to constitute a wall. This integrated body may then be covered with plaster on its outer faces as described above for a single panel.

The inventor's prior patent, U.S. Pat. No. 4,917,284, the disclosure of which is fully incorporated herein by reference, describes apparatus for the automatic production of such building panels. The patented apparatus automatically inserts the transverse wires through the layer of foamed plastic material and welds them in place at their two ends to the opposed faces of the grids.

The apparatus of the '284 patent includes a horizontal panel conveyer onto which the two grids are laid with the layer of foamed plastic material interposed between the grids; a stepped advancement device to advance the panel in a first direction; a vertically movable bridge positioned above the conveyer; a multiplicity of insertion devices supported by the bridge, each suitable for drawing sections of metal wire and inserting the sections of wire into the underlying panel; a multiplicity of cutting devices carried by the bridge, the cutting devices being vertically movable with respect to the bridge, and each being vertically coaxial with a respective insertion device and interposed between the insertion device and the conveyer, each cutting device being also configured to permit the section of wire to run through the panel and be cut substantially flush with the upper grid of the panel once inserted through the layer of foamed plastic material; a multiplicity of lower welding devices supported below the panel conveyer and vertically movable with respect thereto, as well as positioned vertically coaxially with respective ones of the insertion devices and the cutting devices, for welding the lower end of the wires/transverses to the lower metal grid; and a multiplicity of upper welding devices carried for vertical movement by the bridge but positioned one step behind the cutting devices, lower welding devices and insertion devices with respect to the first direction, for welding the upper ends of the wires/transverses to the upper metal grid.

The number of cutting devices, welding devices and insertion devices in the multiplicity is equal to the number of transverses in a row of transverses, so that all of the transverses in a row are operated on at the same time.

Functionally, the system of the '284 patent provides for stepped advancement of the panel by the conveyer; insertion of a multiplicity of sections of metal wire through the foamed layer transverse to the direction of advance; cutting of these sections substantially flush with the upper metal grid to define transverses, actuated by descent of the cutting devices; and simultaneous electrical welding of the transverses to the lower metal grid subsequent electrical welding of the transverses to the upper metal grid and so forth at each step until welding of the transverses is complete.

Such a system, in production, has provided excellent production results, easily achieving panel production of 1,000-1,200 m²/day (eight working hours).

However, this prior art system is relatively expensive to manufacture. Additionally, the system suffers from high running costs due to the amount of electrical power required by the respective large number of moving parts and the apparatus's consumption of large volumes of compressed air needed to assure proper functioning.

There is therefore a heretofore unmet need for a machine that can produce prefabricated modular building panels with increased efficiency and more economically.

### SUMMARY OF THE INVENTION

It is therefore an object of the invention to provide an improved apparatus for manufacturing prefabricated modular building panels and which overcomes the drawbacks of the prior art.

It is a further object of the invention to provide an improved apparatus for the economical manufacture of sandwiched building panels made up of metal grids and foamed plastic material, which nonetheless maintains the characteristics of reliability and production accuracy of the previously patented apparatus.

It is yet another object of the invention to achieve its objects through an automatic machine which is simple, functional and safe to use.

These and other objects are achieved with the inventive simplified apparatus for the production of prefabricated sandwiched building panels made up of first and second opposed grids surrounding an insulating material. A preferred embodiment of the inventive apparatus comprises means for supporting the panel and for moving the panel in a first direction of increments; means for receiving a coiled wire; means for inserting a portion of the wire through the panel, the wire having at least a first end, the first end being inserted through the first grid of the panel by the means for inserting and the means for inserting being configured to insert the wire through the panel to a degree sufficient to cause the first end thereof to extend to a point at least flush with the second grid of the panel; at least one cutter for cutting the wire after the first end of the wire has been inserted through the panel, and forming thereby a second end of the wire disposed proximate to the first grid of the panel; first and second welding devices; first means for incrementally moving the means for inserting, the cutter and the first welding device in a second direction from a first position to a second position, the second direction being transverse to the first direction and the second position being spaced from said first position by a first predetermined distance; and second means for incrementally moving the second welding device in the second direction in tandem with the movement of the first means for incrementally moving; the first welding device being configured to weld the first end of the wire to the second grid when the wire has been inserted through the panel; and the second welding device being configured to weld the second end of the wire to the first grid when the panel has been moved by the means for supporting and moving by a second predetermined distance equal to an integral multiple of one of the increments; wherein the means for inserting is configured to insert the wire through the panel when the panel is in the first position, the wire being inserted through the panel in a third direction transverse to both the first and second directions.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, in which like numerals denote like elements:

FIG. 1 is a front view of a low-cost automatic machine for the production of prefabricated sandwiched building panels made up of metal grids and foamed plastic material in accordance with the present invention;

FIG. 2 is a longitudinal sectional view of the machine of FIG. 1;

FIG. 3 is a partially cut away front view of the machine of FIG. 1, shown during the first run of operation of the machine on a particular panel;

FIG. 4 is a partially cut away front view of the apparatus of FIG. 1, shown during the last run of operation of the machine on a particular panel; and

FIG. 5 is a partial front sectional view of the machine of FIG. 1, highlighting the devices positioned behind those proximately seen in the front view shown in FIG. 3.

### DETAILED DESCRIPTION OF THE PRESENTLY PREFERRED EMBODIMENTS

Shown in the Figures, generally at 100, is a preferred embodiment of an automatic machine constructed in accordance with the invention for the production of prefabricated sandwiched building panels made up of opposed grids and insulating material positioned between the grids. Machine 100 comprises a belt 1 to convey panels 2 through machine 100. Each panel 2 is made up of a layer of an insulating material 3 interposed between opposed electrically welded, rectangular mesh metal grids comprised of an upper metal grid 4A and a lower metal grid 4B. Insulating material 3 may be of any suitable material, such as cork or polystyrene, but is most preferably foamed polystyrene.

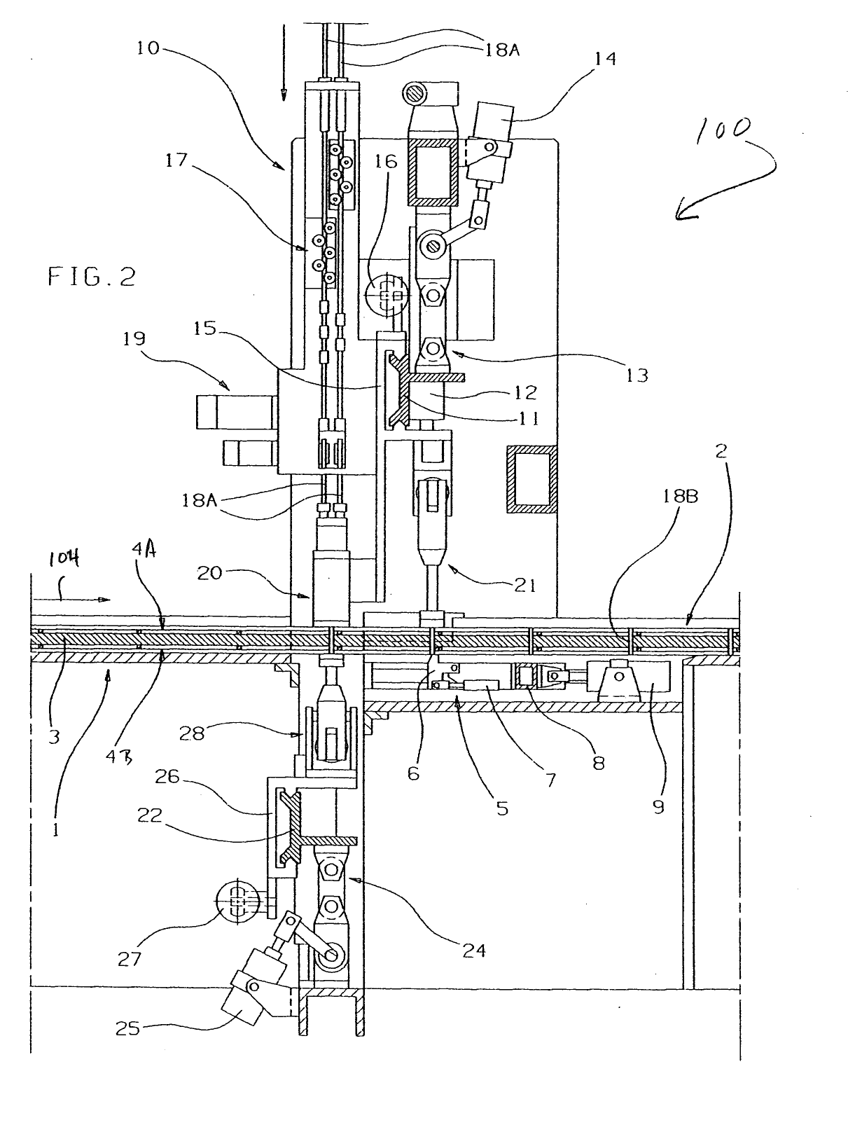

Panels 2 are advanced stepwise incrementally on conveyor belt 1 by an advancement device 5 positioned underneath belt 1. Advancement device 5 preferably includes hooks 6, pistons 7, a bar 8 and a first pneumatic device 9 (all best seen in FIG. 2), although any conventional advancement or conveyor means may be employed. In the preferred embodiment, each hook 6 is coupled to a respective pneumatic piston 7. Pistons 7 are connected to bar 8 which transmits reciprocating horizontal motion supplied by pneumatic device 9 to pistons 7.

A bridge 10 is positioned above conveyor belt 1, and supports an upper rail 11, cylindrical guides 12, a first reciprocating motion device 13 and a second pneumatic device 14. An upper carriage 15 slides on upper rail 11.

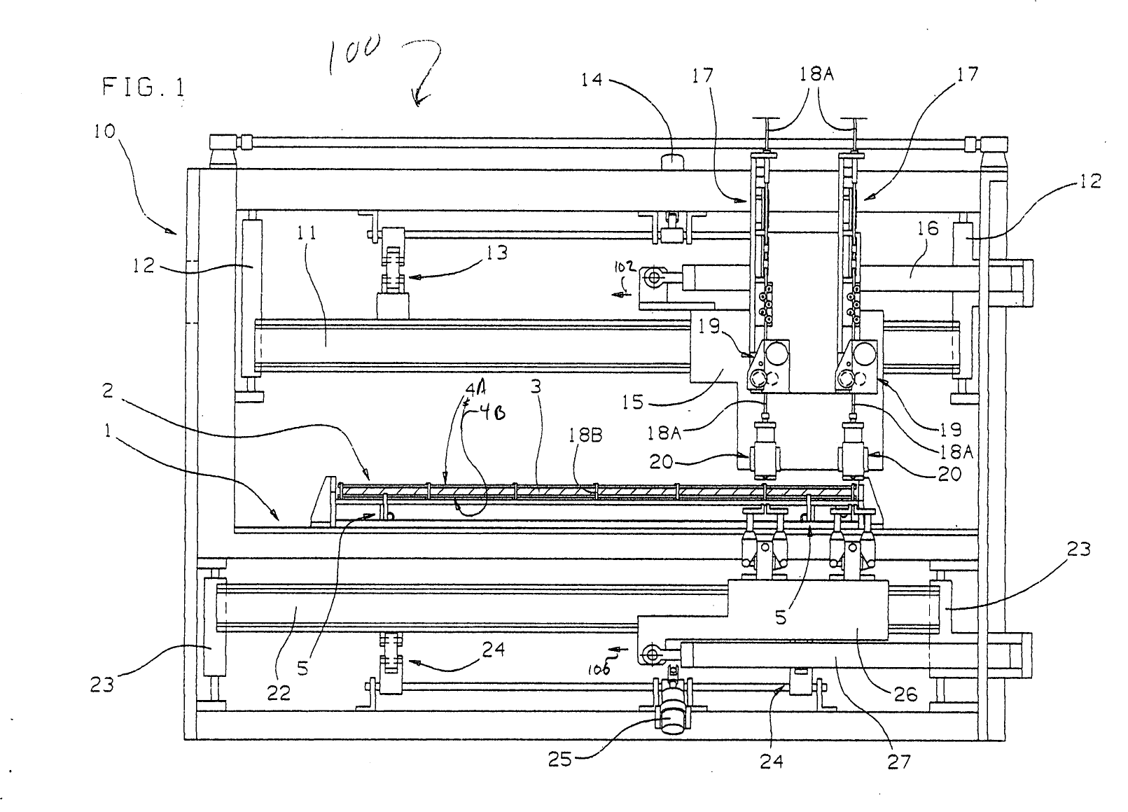

Second pneumatic device 14 drives first reciprocating device 13 to move upper rail 11 vertically within cylindrical guides 12. A third pneumatic device 16 is positioned to also slide within guides 12 in parallel with upper rail 11, and drives upper carriage 15 horizontally in the direction shown by arrow 102 in FIG. 1.

A pair of guiding and straightening devices 17 are positioned side by side on upper carriage 15 and substantially perpendicular to conveyor belt 1. At least one metal wire 18A runs inside each guiding and straightening device 17, uncoiled from the top from coils (not shown) received from a reservoir (not shown). In an embodiment of the invention seen in FIG. 2, two wires simultaneously run through each guiding and straightening device 17 to provide increased stability and durability to the finished product.

Machine 100 further includes wire drawing and insertion devices 19, each positioned below, and vertically coaxial with, a respective guiding and straightening device 17. Each wire drawing and insertion device 19 includes a plurality of rollers, preferably rollers manufactured in accordance with the inventor's prior U.S. Pat. No. 5,547,118 the disclosure of which is fully incorporated herein by reference.

Upper carriage 15 also supports a pair of cutting devices 20, respectively positioned below the pair of drawing and insertion devices 19 in continuation of the descent trajectory of the pairs of metal wires 18A. Cutting devices 20 are preferably composed of shears of the type described in U.S. Pat. No. 5,547,118, and are operable to cut wire 18A so as to form transverses 18B that are left within panel 2. Preferably, adjacent transverses 18B are evenly spaced along panel 2.

Upper carriage 15 also carries upper electric welding devices 21, each positioned behind cutting devices 20 with reference to the direction in which panels 2 advance (indicated by arrow 104 in FIG. 2) by a distance equal to one increment of the stepwise travel of machine 100 along the surface of panel 2, i.e., by the distance between adjacent transverses 18B in the finished panel 2 in the direction shown by arrow 104. Upper electric welding devices 21 are also positioned so that they are substantially parallel to respective cutting devices 20 (see FIG. 2).

Machine 100 further includes a vertically movable lower rail 22 supported beneath conveyor belt 1 on cylindrical guides 23. Lower rail 22 is vertically movable within guides 23 by means of a second reciprocating motion mechanism 24 driven by a fourth pneumatic device 25. A lower carriage 26 is slidably mounted on lower rail 22 for movement in the direction indicated by arrow 106 by a fifth pneumatic device 27.

A pair of lower electric welding devices 28 are assembled on lower carriage 26 in side by side relation. Lower welding devices 28 are co-axial with respective guiding and straightening devices 17, drawing and insertion devices 19 and cutting devices 20 (FIG. 2).

Automatic machine 100 operates in the following manner.

Panel 2 is preformed with opposed top and bottom grids 4A and 4B sandwiching insulating material 3 therebetween, and placed on belt 1 so that one end of panel 2 is placed underneath one guiding and straightening device 17, drawing and insertion device 19 and cutting device 20 (FIG. 1). Panel 2 is incrementally stepwise advanced on conveyor belt 1 by advancement device 5 so that panel 2 substantially stops underneath cutting devices 20 for a period of time sufficient to execute the operations described below (see FIG. 1). Each increment, or step, represents the desired separation between adjacent transverses 18B in succeeding rows of transverses.

At each point at which advancement device 5 stops, a section of metal wire 18A is uncoiled from each drawing and insertion device 19 and inserted through the layer of insulating material 3 of panel 2.

Upper rail 11 is then driven downwardly by reciprocating motion device 13, actuated by pneumatic device 14, until wire 18A extends completely through panel 2 to lower metal grid 4B. Cutting devices 20 likewise move downward and cut wire 18A at approximately the level of the surface of upper metal grid 4A, thus isolating a respective transverse 18B which remains within panel 2 to perforate the layer of insulating material 3 (see also FIG. 2).

Substantially simultaneously with the descent of cutting devices 20, lower rail 22 and lower welding devices 28 are raised upward. Lower welding devices 28, having appropriately shaped and dimensioned jaws (such as described in U.S. Pat. No. 4,917,284), weld the bottom ends of transverses 18B to lower metal grid 4B substantially simultaneously with the cutting of wire 18A by cutters 20.

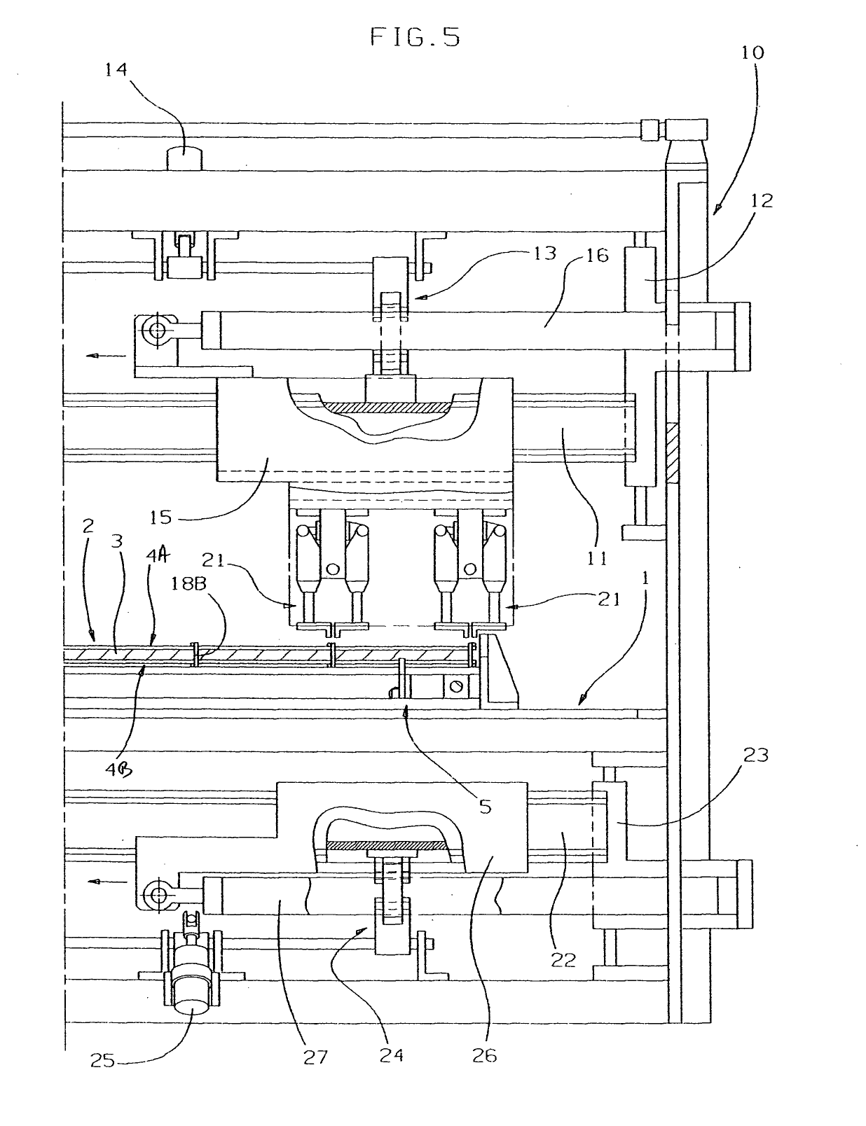

Also at the same time, the back pair of upper welding devices 21 (FIG. 2) are carried by upper rail 11 to descend in tandem with cutting devices 20, one incremented step behind cutting devices 20 (in the direction indicated by arrow 104 in FIG. 2), and weld the top ends of previously cut transverses 18B to upper metal grid 4A (see also FIG. 5). It will be appreciated that, on the first pass of panel 2 through machine 100, no transverses 18B exist at the current position of upper welding devices 21, so that no welding takes place. This part of the welding process only occurs when a cut end of a transverse 18B is in position for upper welding devices 21 to act thereupon, i.e., on the second and subsequent passes of panel 2 through machine 100.

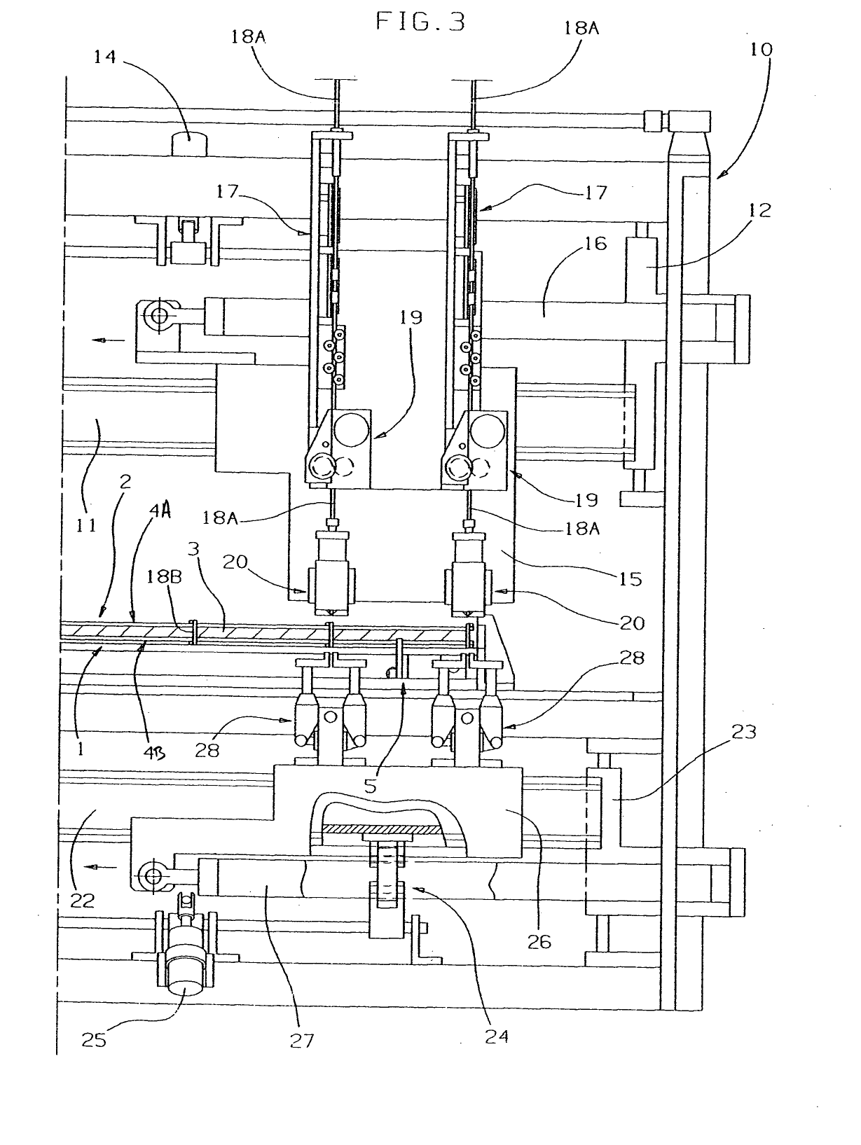

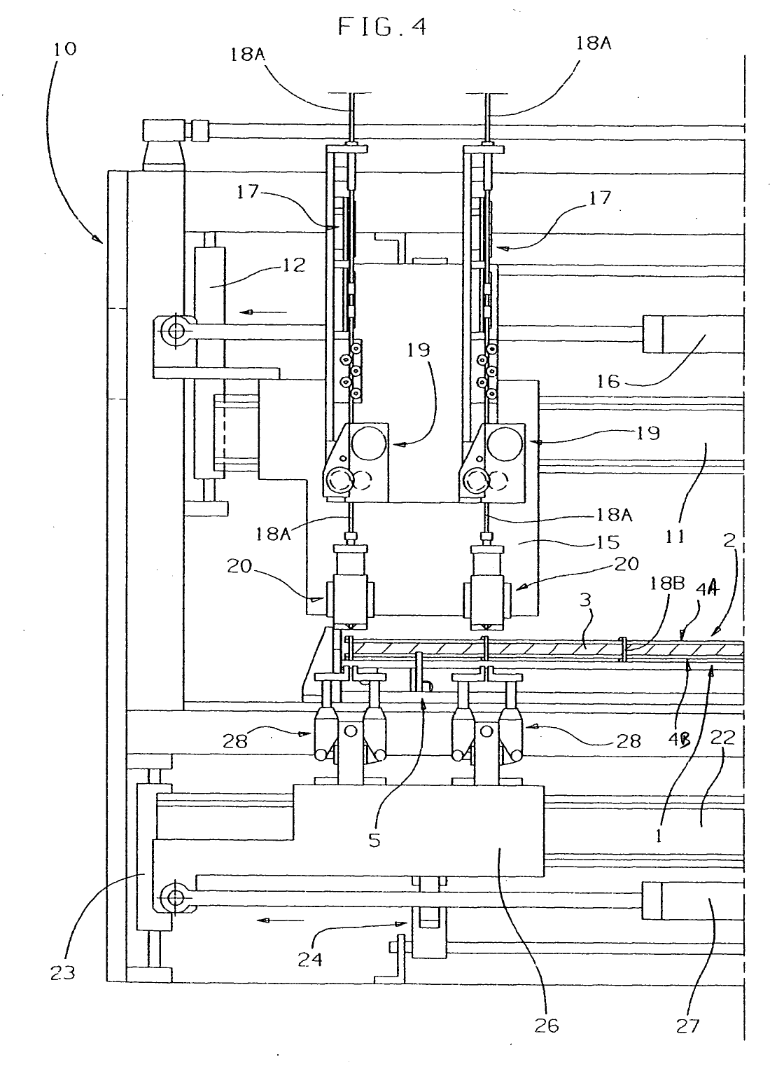

After this first step of operation, upper carriage 15 on upper rail 11 and lower carriage 26 on lower rail 22 simultaneously slide sideways (i.e., transverse to the direction of movement 104 of panel 2) in parallel by an identical distance (see also FIGS. 3 and 4) in the direction shown by arrows 102 and 106, respectively.

By virtue of such parallel movement, the overlying pair of guiding and straightening devices 18, drawing and insertion devices 19, cutting devices 20 and upper welding devices 21, as well as the underlying pair of lower welding devices 28, are simultaneously translated sideways to an appropriate position to, with the same motion of mechanisms just described, insert two additional transverses 18B disposed lateral to the first pair and transversely in line therewith through the layer of insulating material 3 and weld them to metal grid 4B.

This process continues until completion of a row of transverses 18B, at which time panel 2 is advanced in the direction denoted by arrow 104 in FIG. 2. Upper carriage 15 and lower carriage 26 are then retracted to their original positions by respective third pneumatic device 16 and fifth pneumatic device 27 for insertion of a new row of transverses 18B through panel 2 at a next step, and so forth until all desired transverses 18B are inserted into panel 2 and welded to grids 4A, 4B, to thereby complete the desired welding of panel 2 conveyed on belt 1. It will be appreciated that, just as the insertion of the first row of transverses 18B is not accompanied by a simultaneous welding of a preceding row of transverses 18B since there is no such preceding row, the welding of the upper ends of the final row of transverses 18B is not accompanied by insertion of a next-succeeding row of transverses 18B because all such rows will have already been inserted.

As should also be evident in additional alternative embodiments that nonetheless fall within the scope of the invention as exemplified by the embodiment described above and as claimed below, the automatic machine of the invention may be implemented and realized in other ways using equivalent techniques and mechanics and/or additional integrated devices, that nevertheless come within the inventive concept as herein described and claimed.

In particular, one of ordinary skill in the art will appreciate that drawing and insertion devices 19, cutting devices 20, upper welding device 21 and lower welding devices 28 of wires 18A and transverses 18B may alternatively be implemented or constructed in any conventional or appropriate way suited to the intended purpose and functionality. One such alternative is the relative tilting of these elements with respect to the perpendicular as for example shown in U.S. Pat. No. 5,547,118.

For example, third pneumatic device 16 and fifth pneumatic device 27 may be replaced by any mechanism suitable to impart transverse motion to upper carriage 15 and lower carriage 26, respectively.

It is also contemplated to substitute racks or toothed belts and electric motors in place of the mechanical and/or pneumatic devices described above to potentially improve or enhance the operating accuracy and adjustability of automatic machine 100.

Upper carriage 15 and lower carriage 26 may also be supported in any conventional or otherwise suitable manner as a matter of design choice.

Those of ordinary skill will also appreciate that other forms of fastening devices may be substituted for metal wire 18, such as metal rods (as discussed in U.S. Pat. No. 4,917,284) or staples. If the fastening device is pre-cut to a length substantially equal to the thickness of panel 2, then no cutting device 20 will be required.

Reciprocating motion devices 13, 24 driven by second and fourth pneumatic devices 14, 25, respectively, for imparting reciprocating vertical motion to upper rail 11 and lower rail 22 and respective guides 12, 23 may also be replaced with any other suitable motion devices and/or guides.

The wires/transverses 18A, 18B inserted through panel 2 may also be formed in pairs to further strengthen the structure of the resulting panel 2.

It will be further appreciated that, although the presently preferred embodiment of the invention utilizes pairs of guiding and straightening devices 19, drawing and inserting devices 19, cutters 20, upper welding devices 21 and lower welding devices 28, machine 100 can instead operate with only one set of such devices, or with more than two sets of such devices, as a matter of design choice, and/or depending upon the width of panel 2. Two such sets of devices is currently preferred for most commercial applications.

Moreover, those of ordinary skill in the art will appreciate that although the distance by which panel 2 is advanced in the direction indicated by arrow 104 in FIG. 2 is preferably defined by the distance separating cutting device 20 from upper welding device 22, that distance may be altered to a smaller spacing to provide for added rows of transverses 18B in panel 2, so long as the distance separating cutting device 20 from upper welding device 22 is an integral multiple of the separation distance to preserve the operating ability of machine 100 to simultaneously handle one row of cutting and one row of upper welding. In a so-modified embodiment, the first two (or more) passes of panel 2 through machine 100 will have no welding performed by welding devices 21 until the first row of transverses 18 is moved into position beneath upper welding devices 21, and the last equal number of passes will have no insertion, cutting and lower welding performed once the cutting devices pass beyond the edge of panel 2.

In practice, the automatic machine 100 as herein described has a smaller footprint and offers improved accuracy as compared to prior art devices.

The present invention thus provides a simplified system for the production of prefabricated sandwiched building panels made up of metal grids and foamed plastic material that achieves the production characteristics and construction quality fully corresponding to that expected from more complex systems, while at the same time allowing considerable savings, especially in running costs and markedly lower energy consumption as compared to that required for operation of more complex prior art systems.

In addition to the decreased consumption of electrical energy by virtue of its use of a reduced number of welders, a markedly lower volume of compressed air need be supplied for proper functioning of the machine where blasts of air are directed at the welders to prevent deposits of residues from perforating the foamed plastic material and thereby potentially compromising the electrical welds. In a simplified machine according to the present invention, four diffusers are sufficient as contrasted with the twelve diffusers of heretofore known systems.

Moreover, these savings do not translate into a proportional loss of productivity. To the contrary, productivity is greater than in known systems; known systems achieve panel productions of 1,000-1,200 m²/day with six operating heads, wherein the machine of the preferred embodiment of the present invention with only two transversely movable operating heads can achieve productions of 700 m²/day.

Thus, while there have been shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. Apparatus for the production of a prefabricated sandwiched building panel made up of first and second opposed grids surrounding an insulating material, said apparatus comprising:
means for supporting said panel and for moving said panel in a first direction by defined increments;
means for receiving fastening means;
means for inserting a portion of said fastening means through said panel, each portion of said fastening means having at least a first end, said first end being inserted through said first grid of said panel by said means for inserting and said means for inserting being configured to insert said fastening means through said panel to a degree sufficient to cause said first end to extend to a point at least flush with the surface of said second grid of said panel;
first and second securing devices;
first means for incrementally moving said means for inserting and said first securing device in a second direction from a first position to a second position, said second direction being transverse to said first direction, and said second position being spaced from said first position by a predetermined distance; and
second means for incrementally moving said second securing device in said second direction, said second means for incrementally moving operating in registry with said first means for incrementally moving;
said first securing device facing said second grid of said panel and being configured to secure said first end of said fastening means to said second grid when said fastening means has been inserted through said panel; and
said second securing device facing said first grid of said panel and being configured to secure a second end of said fastening means to said first grid when said panel has been moved by said means for supporting and moving by a second predetermined distance equal to an integral multiple of one of said increments;
wherein said means for inserting inserts said fastening means through said panel in a third direction substantially transverse to said first and second directions.

2. The apparatus of claim 1, wherein said means for inserting and said first securing device are positioned substantially coaxially with respect to one another.

3. The apparatus of claim 1, wherein said fastening means is formed to be longer than the thickness of said panel, and wherein said apparatus further comprises a cutter for cutting said fastening means after said fastening means is inserted into said panel, to thereby form said second end of said fastening means.

4. The apparatus of claim 3, wherein said cutter faces said second grid of said panel and is substantially co-axial with said means for inserting and said first securing device.

5. The apparatus of claim 3, wherein said fastening means comprises a coiled wire.

6. The apparatus of claim 1, wherein at least one of said first and second securing devices comprises a welding device.

7. Apparatus for the production of a prefabricated sandwiched building panel made up of first and second opposed grids surrounding an insulating material, said apparatus comprising:
means for supporting said panel and for moving said panel in a first direction by increments;
means for receiving a coiled wire;
means for inserting a portion of said wire through said panel, said wire having at least a first end and said first end being inserted through said first grid of said panel by said means for inserting and said means for inserting being configured to insert said wire through said panel to a degree sufficient to cause said first end of said wire to extend to a point at least flush with said second grid of said panel;
a cutter for cutting said wire after said first end of said wire has been inserted through said panel and forming thereby a second end of said wire disposed proximate said first grid of said panel;
first and second welding devices;
first means for incrementally moving said means for inserting, said cutter and said first welding device in a second direction from a first position to a second position, said second direction being transverse to said first direction and said second position being spaced from said first position by a first predetermined distance; and
second means for incrementally moving said second welding device in said second direction in tandem with the movement of said first means for incrementally moving;
said first welding device being configured to weld said first end of said wire to said second grid when said wire has been inserted through said panel; and
said second welding device being configured to weld said second end of said wire to said first grid when said panel has been moved by said means for supporting and moving by a second predetermined distance equal to an integral multiple of one of said increments;
wherein said means for inserting is configured to insert said wire through said panel when said panel is in said first position, said wire being inserted through said panel in a third direction transverse to both said first and second directions.

8. The apparatus of claim 7, wherein said wire is inserted through said panel along a first axis, and wherein said means for insertion is movable along said first axis.

9. The apparatus of claim 8, wherein said cutter is movable along said first axis.

10. The apparatus of claim 8, wherein said first welding device is movable along said first axis.

11. The apparatus of claim 8, wherein said second welding device is movable along a second axis, said second axis being substantially parallel to said first axis and spaced therefrom by said predetermined distance.

12. The apparatus of claim 7, wherein:
said means for inserting comprises a pair of inserting devices;
said cutter comprises a pair of cutters,
said first welding device comprises a pair of first welding devices; and
said second welding device comprises a pair of second welding devices.

13. The apparatus of claim 12, wherein respective ones of said pair of said means for inserting, said pair of cutters and said pair of first welding devices are positioned substantially co-axially along a first axis, and a respective one of said pair of second cutting devices has a second axis that is substantially parallel to said first axis.

14. The apparatus of claim 7, wherein said integral multiple is 1.

15. The apparatus of claim 7, further comprising a first vertically movable means, movable in said third direction, for moving said means for inserting, said cutter and said first welding device in registry.

16. The apparatus of claim 15, wherein said first means for incrementally moving comprises first transverse movement means for moving said means for inserting, said cutter and said first welding device in said second direction, said first transverse movement means being mounted to said vertically movable means.

17. The apparatus of claim 16, wherein said first vertically movable means comprises one of a first vertically movable rail and a first vertically movable guide, and a first carriage mounted to slide relative to said one of first rail and said first guide for carrying said means for inserting, said first welding device and said cutting device, said first carriage being slidable in said second direction.

18. The apparatus of claim 16, further comprising a second vertically movable means, movable in said third direction, for moving said second welding device, and a second transverse movement means, slidably mounted to said second vertically movable means, for moving said second welding device in said second direction substantially in tandem with the movement of said means for inserting, said cutter and said first welding device.

19. The apparatus of claim 18, wherein said second transverse movement means comprises one of a second vertically movable rail and a second vertically movable guide, and a second carriage mounted to slide relative to said one of said second rail and said second guide for carrying said second welding device.

20. The apparatus of claim 18, wherein said first and second transverse movement means move substantially in parallel.
